(19) United States
(12) Patent Application Publication
(10) Pub. No.: US 2001/0043016 A1
(43) Pub. Date: Nov. 22, 2001

(54) Linear motor

(76) Inventors: Jang Sung Chun, Seoul (KR); Do Hyun Kim, Kyungki-do (KR); Ji Hyun Hwang, Kyungki-do (KR)

Correspondence Address: BIRCH STEWART KOLASCH & BIRCH, PO BOX 747, FALLS CHURCH, VA, 22040-0747, US

(21) Appl. No.: 09/761,592

(22) Filed: Jan. 18, 2001

(30) Foreign Application Priority Data
May 20, 2000 (KR) 2000-27229

(51) Int. Cl. H02K 41/00

(52) U.S. Cl. 310/12

(57) ABSTRACT

A linear motor includes an outer case; a stator installed at the inner side the outer case and having a first and a second armature coil parts; a first to a third shafts assembled in the inner side of the first and the second armature coil parts of the stator; a first permanent magnet part having a plurality of permanent magnets assembled in a ring-type at the outer circumferential surface of the first shaft; and a second permanent magnet part having a plurality of permanent magnets assembled at the outer circumferential surface of the third shaft. Since the first permanent magnet and the second permanent magnet are separately constructed on the outer circumferential surface of the shaft to be assembled, the linear movement of the linear motor can be precisely controlled when the linear motor is linearly moved, and the permanent magnet to be assembled at the rotation movement zone can be attached later.

### BACKGROUND OF THE INVENTION

1. Field of the Invention

The present invention relates to a linear motor, and more particularly, to a linear motor having a plurality of permanent magnets assembled with a shaft which is moved rotatably and linearly.

2. Description of the Background Art

FIG. 1 is a sectional view of a linear motor in accordance with a conventional art, and FIG. 2 illustrates arrangement of permanent magnets of the linear motor of FIG. 1 in accordance with the conventional art.

Generally, as shown in the drawings, a linear motor includes a stator 1 and a rotor 2.

The stator 1 includes an outer case 1a, a first armature coil part 1b installed inner side of the outer case 1a, a second armature coil part 1c installed at one side of a support member 1d.

The rotor 2 includes a shaft 2b and permanent magnets 2a arranged in a checked pattern at an outer circumferential surface of the shaft 2b.

The first armature coil part 1b is wound in an annular type at the inner side of the stator 1, and the second armature coil part 1c is also wound in the same annular type as that of the first armature coil part lb at the inner side of the stator 1 but arranged in a checked pattern in a perpendicular direction to the first armature coil part 1b.

The first armature coil part 1b is linearly moved, while the second armature coil part 1c assembled in the direction perpendicular to the first armature coil parts 1b is rotatably moved. And, the first armature coil part 1b and the second armature coil part 1c are formed of three-phase (U, V, W, U′, V′, W′) coils.

However, in the case that the first and the second armature coil parts 1b and 1c adopt the three phases, in the conventional linear motor, the plurality of permanent magnets corresponding to the first armature coil part, that is, the linear movement portion, and the second armature coil part, that is, the rotation movement portion, are arranged and assembled in a checked pattern on the outer circumferential surface of a single shaft. Thus, when the shaft is linearly moved, it is difficult to precisely control the shaft due to the permanent magnets in the checked pattern. In addition, since assembling the permanent magnets in the checked pattern is very difficult, its operation efficiency is degraded.

### SUMMARY OF THE INVENTION

Therefore, an object of the present invention is to provide a linear motor in which a plurality of permanent magnets arranged and assembled on the outer circumferential surface of a shaft are divided into a first permanent magnet part, a linear movement zone, and a second permanent magnet part, a rotation movement zone, in a manner of being corresponded to a first armature coil part and a second armature coil part as divided into a rotation movement zone and a linear movement zone, to thereby precisely control linear movement thereof To achieve these and other advantages and in accordance with the purpose of the present invention, as embodied and broadly described herein, there is provided a linear motor including: an outer case; a stator installed at the inner side the outer case and having a first and a second armature coil parts; a first to a third shafts assembled in the inner side of the first and the second armature coil parts of the stator; a first permanent magnet part having a plurality of permanent magnets assembled in a ring-type at the outer circumferential surface of the first shaft; and a second permanent magnet part having a plurality of permanent magnets assembled at the outer circumferential surface of the third shaft.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view of a linear motor in accordance with a conventional art;

FIG. 2 illustrates arrangement of permanent magnets of the linear motor of FIG. 1 in accordance with the conventional art;

FIG. 3 is a sectional view of a linear motor in accordance with the present invention;

FIG. 4A is a perspective view of a stator of the linear motor of FIG. 3 in accordance with the present invention;

FIG. 4B is a perspective view of a rotor of the linear motor of FIG. 3 in accordance with the present invention;

FIG. 5A is a side-sectional view of the stator of the linear motor of FIG. 3 in accordance with the present invention; and

FIG. 5B is a side-sectional view of the rotor of the linear motor of FIG. 3 in accordance with the present invention.

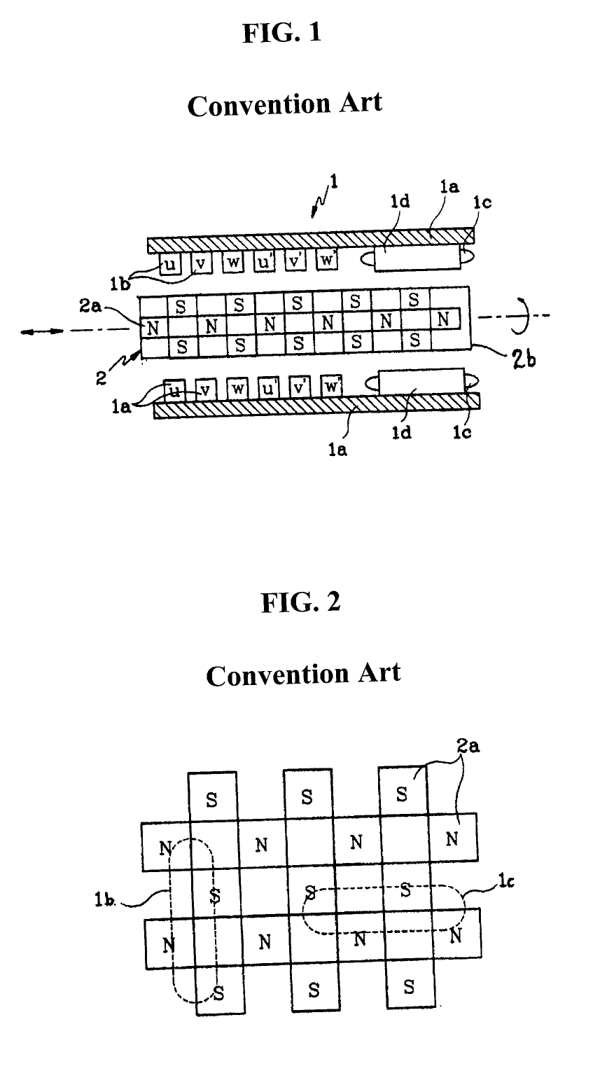

### DETAILED DESCRIPTION OF THE PREFERRED EMBODIMENTS

Reference will now be made in detail to the preferred embodiments of the present invention, examples of which are illustrated in the accompanying drawings.

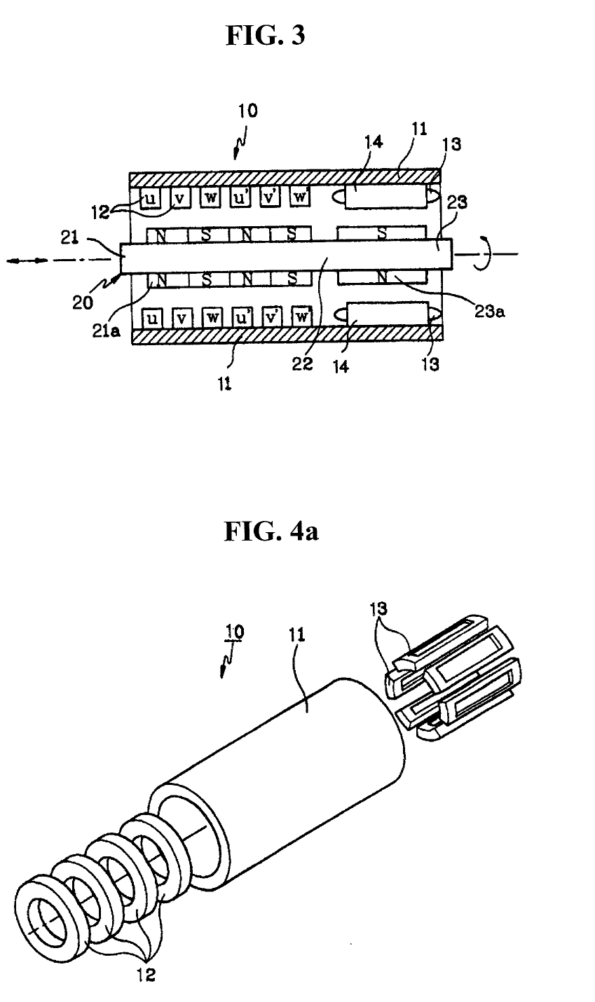

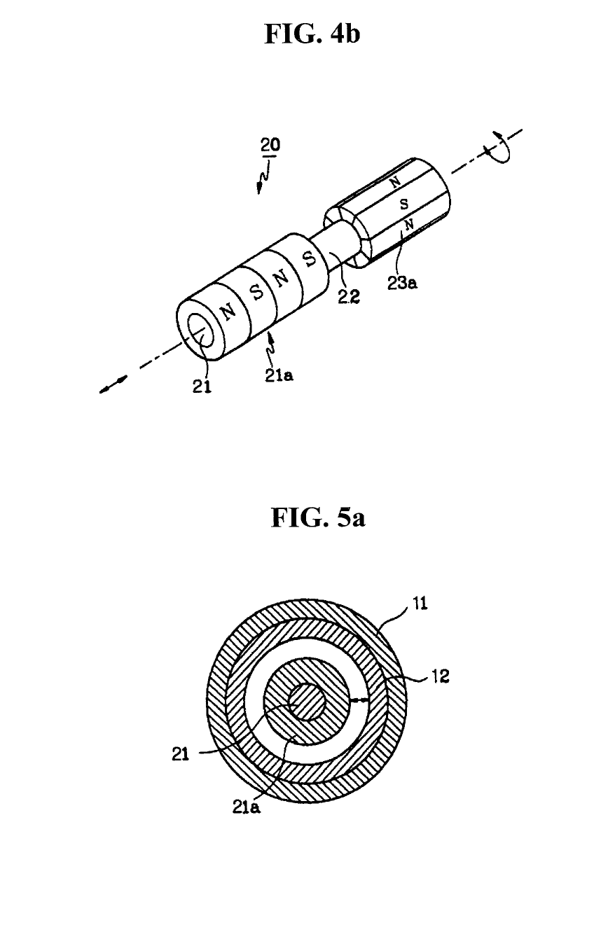

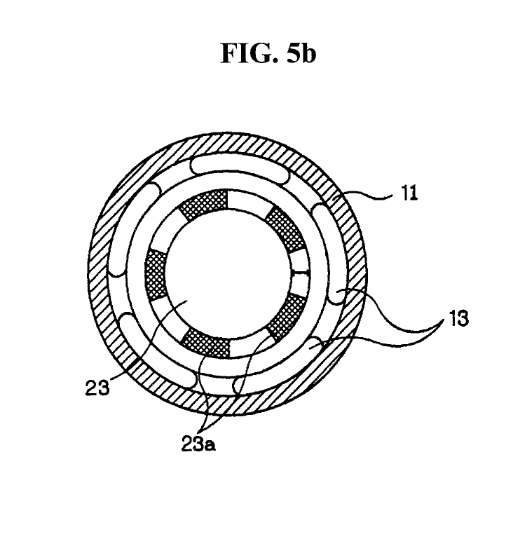

FIG. 3 is a sectional view of a linear motor in accordance with the present invention, FIG. 4A is a perspective view of a stator of the linear motor of FIG. 3 in accordance with the present invention, FIG. 4B is a perspective view of a rotor of the linear motor of FIG. 3 in accordance with the present invention, FIG. 5A is a side-sectional view of the stator of the linear motor of FIG. 3 in accordance with the present invention, and FIG. 5B is a side-sectional view of the rotor of the linear motor of FIG. 3 in accordance with the present invention.

As shown in FIG. 3, a linear motor of the present invention includes a stator 10 and a rotor 20.

With reference to FIGS. 3 and 4A, the stator 10 includes a first armature coil part 12 disposed at one side of an outer case 11 and a second armature coil part 13 disposed at a predetermined distance from the first armature coil part 12.

The first armature coil part 12 and the second armature coil part 13 are formed in a similar structure to that of the armature coil parts of the conventional linear motor.

Namely, the first armature coil part 12 is disposed in the annular type to fit the outer case 11, and the second armature coil part 13 is assembled in the outer case 11 in the perpendicular direction to the first armature coil part 12. A reference numeral 14 of FIG. 3 denotes a support member.

With reference to FIGS. 3 and 4B, the rotor 20 includes a first through a third shafts 21, 22 and 23 insertedly disposed in the outer case 11, a first permanent magnet 21a disposed in a ring type on the outer circumferential surface of the first shaft 21 and a second permanent magnet 23a disposed on the outer circumferential surface of the third shaft 23.

The first and the second permanent magnet 21a and 23a are positioned to be corresponded to the first and the second armature coil parts 12 and 13, respectively.

The reason why the rotor is sectioned into the first through the third shafts 21, 22 and 23 is to indicate a linear movement zone, a neutral zone, and a rotation movement zone.

As shown in FIGS. 4B and 5A, N pole, S pole, N pole and S pole of the first permanent magnet 21a are arranged in a ring type on the outer circumferential surface of the first shaft 21 in the horizontal direction in the linear movement zone.

The N pole, S pole, N pole and S pole of the second permanent magnet 23a are arranged on the outer circumferential surface of the third shaft 23 in the vertical direction in the rotation movement zone.

There is formed the neutral zone between the first permanent magnet 21a and the second permanent magnet 23a, having a predetermined interval therebetween. The neutral zone corresponds to the second shaft 22 as shown in FIG. 4B.

As to the linear motor of the present invention constructed as described above, since the rotor 20 is formed to be coaxial with the first through the third shafts 21, 22 and 23, its precision can be drastically improved compared with that of the conventional linear motor.

In other words, in case of the conventional linear motor, the shaft for the linear movement zone and the shaft for the rotation movement zone are Functioned for use, but comparatively, in case of the linear motor of the present invention, the plurality of permanent magnets formed on the outer circumferential surface of the shaft are divided into the first permanent magnet 21a, the linear movement zone, and the second permanent magnet 23a, the rotation movement zone, and the first permanent magnet 21a is formed in a ring type to be assembled, so that controlling of the linear movement of the linear motor, which is moved rotatably and linearly, can be improved. In addition, the permanent magnet to be assembled in the rotation movement zone of the shaft can be attached later.

As so far described, according to the linear motor of the present invention, the first permanent magnet and the second permanent magnet are separately constructed on the outer circumferential surface of the shaft to be assembled, so that the linear movement of the linear motor can be precisely controlled when the linear motor is linearly moved, and the permanent magnet to be assembled at the rotation movement zone can be attached later.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A linear motor comprising:
an outer case;
a stator installed at the inner side the outer case and having a first and a second armature coil parts;
a rotor includes a first to a third shafts assembled in the inner side of the first and the second armature coil parts of the stator;
a first permanent magnet part having a plurality of permanent magnets; and
a second permanent magnet part having a plurality of permanent magnets assembled on the outer circumferential surface of the third shaft.

2. The linear motor according to claim 1, wherein the first armature coil part of the stator is disposed in the annular type to fit the outer case.

3. The linear motor according to claim 1, wherein the second armature coil part of the stator is assembled in the outer case in the perpendicular direction to the first armature coil part.

4. The linear motor according to claim 1, wherein the first to the third shafts are provided with a neutral zone (which corresponds to the second shaft portion) therebetween, having a predetermined interval between the first permanent magnet part assembled on the outer circumferential surface of the first shaft and the second permanent magnet part assembled on the outer circumferential surface of the second shaft.

5. The linear motor according to claim 1, wherein the first permanent magnet is arranged in a ring type on the outer circumfenential surface of the shaft.

6. The linear motor according to claim 1, wherein the second permanent magnet is arranged on the outer surface of the third shaft in the vertical direction.
